(19) United States
(12) Patent Application Publication
(10) Pub. No.: US 2009/0205978 A1
(43) Pub. Date: Aug. 20, 2009

(54) MEASURING DEVICE FOR PERMEATION RATE OF WATER AND OXYGEN OF PROTECTIVE LAYER IN ORGANIC ELECTRONIC DEVICE AND MEASURING METHOD USING THE DEVICE

(75) Inventors: Byeong Kwon JU, Seoul (KR); Jin Hwan Choi, Seoul (KR); Young Min Kim, Seoul (KR); Young Wook Park, Seoul (KR)

Correspondence Address: RABIN & Berdo, PC, 1101 14TH STREET, NW, SUITE 500, WASHINGTON, DC, 20005, US

(73) Assignee: Korea University Industrial & Academic Collaboration Foundation, Seoul (KR)

(21) Appl. No.: 12/033,788

(22) Filed: Feb. 19, 2008

(51) Int. Cl. G01F 1/64; G01N 27/26

(52) U.S. Cl. 205/791; 204/415

(57) ABSTRACT

A device and method for measuring water and oxygen permeation rates of a protective layer in an organic electronic device are provided. The device includes: a glass substrate; a pair of electrode layers facing each other and deposited on the glass substrate; a calcium layer deposited on the glass substrate; a water and oxygen permeable substrate deposited on the calcium layer; a target protective layer of an organic electronic device, which is deposited on the water and oxygen permeable substrate; and a sealing material applied along an edge of the target protective layer, wherein one ends of the pair of electrode layers are buried in the calcium layer and the other ends are electrically connected to an external resistance measuring device.

Accordingly, high reliability can be achieved, applicability to various processes for the protective layer in the organic electronic device can be enhanced without affecting reflectance or transmittance of the protective layer, and a defect averaging operation does not need to be performed on a calcium layer within the device unlike the conventional art, by using a principle that electrical characteristics of the device are changed when the water or oxygen permeates the protective layer.

### BACKGROUND OF THE INVENTION

1. Field of the Invention

The present invention relates to a device for measuring water and oxygen permeation rates of a protective layer in an organic electronic device and a measuring method using the same, and more particularly, to a device for measuring water and oxygen permeation rates of a protective layer in an organic electronic device which uses a principle that electrical characteristics of the device are changed when the water or oxygen permeates the protective layer so that high reliability can be achieved, applicability to various processes for the protective layer in the organic electronic device can be enhanced without affecting the reflectance or transmittance of the protective layer, and a defect averaging operation does not need to be performed on a calcium layer within the device, unlike the conventional art, and a measuring method using the permeation rate measuring device.

2. Description of the Related Art

An organic light emitting diode (OLED) is a self emissive display device which electrically excites a fluorescent organic compound to emit light. Since the OLED can be driven at a low voltage, can be thin-sized, and has a wide viewing angle and a fast response time, it is receiving attention as a next-generation display capable of solving problems that have been pointed out in a liquid crystal display device (LCD).

However, a light emitting layer and other functional layers which constitute an organic electronic device including the OLED are formed of organic materials, and are susceptible to external environment, in particular, water and air due to inherent properties of the organic material to cause its lifetime to be shortened, so that an encapsulation structure or a hermetic sealing structure for preventing permeation of water and air is required in order to ensure a long lifetime without changes in its color purity and characteristics even when it is used for a long period of time.

According to conventional methods, in order to prevent water and air from permeating into the organic electronic device, a metallic can or glass is processed in a cap shape to have a groove and then is applied as a drying agent for absorbing the water in the groove using powder, or is fabricated in a film shape which is then adhered to the device by means of a double-coated adhesive tape (see U.S. Pat. No. 5,771,562 and Japan Laid-Open Patent Application Hei 3 (1991)-261091). In addition, a method of alternately depositing an organic material and an inorganic material on the top of an organic electroluminescent portion to form a protective layer is employed (see U.S. Pat. Nos. 6,266,695 and 6,570,325).

Accordingly, developments of a device and method capable of effectively, accurately, and easily measuring water and oxygen permeation rates of various organic materials and inorganic materials which can be employed in the organic electronic device are the first consideration for developing an encapsulation structure or a hermetic sealing structure of the organic electronic device. In the protective layer currently employed for the organic electronic device, water and oxygen permeation rates must be very accurately measured up to values of 10⁻⁶ g/m²/day and 10⁻³ g/m²/day at proper temperature and pressure, respectively.

In a case of conventional equipment manufactured by Mocon Inc. (situated in Minneapolis, Minn., U.S.A.) which is widely employed for measuring the water permeation rate of the organic electronic device, it can measure the water permeation rate in a limited range up to 5×10⁻³ g/m²/day. However, such a measurement range makes it difficult to quantitatively obtain an accurate measurement when the protective layer of the organic electronic device is fabricated. Alternatively, a method of optically analyzing a surface of an oxidized calcium layer and measuring a degree of oxidation to measure the water permeation rate while observing a growth of point defects of the calcium layer over time, or a method of measuring the water permeation rate by measuring reflectance or transmittance of the surface and the degree of oxidation is also disclosed.

However, the problem with these methods is that the transmittance of each point is measured over the entire area of the calcium layer to obtain an average value, and the protective layers have initial transmittances and wavelength regions which are different from each other so that the methods require a very complicated operation.

### SUMMARY OF THE INVENTION

The present invention is directed to a device for measuring water and oxygen permeation rates of a protective layer in an organic electronic device, which has high reliability, has enhanced applicability to various processes for the protective layer in the organic electronic device, does not affect reflectance or transmittance of the protective layer, and does not require that a defect averaging operation be performed on a calcium layer within the device.

The present invention is also directed to a method of measuring water and oxygen permeation rates of the protective layer in the organic electronic device using the permeation rate measuring device.

A first aspect of the present invention provides a device for measuring water and oxygen permeation rates of a protective layer in an organic electronic device, which includes: a glass substrate; a pair of electrode layers facing each other and deposited on the glass substrate; a calcium layer deposited on the glass substrate; a water and oxygen permeable substrate deposited on the calcium layer; a target protective layer of an organic electronic device, which is deposited on the water and oxygen permeable substrate; and a sealing material applied along an edge of the target protective layer, wherein one ends of the pair of electrode layers are buried in the calcium layer and the other ends are electrically connected to an external resistance measuring device.

According to an exemplary embodiment of the present invention, the electrode layers may be formed of an Ag material layer or an Au material layer.

According to another exemplary embodiment, the calcium layer may have a deposited thickness of 50 nm to 500 nm.

According to still another exemplary embodiment, the water and oxygen permeable substrate may be formed of plastic selected from a group consisting of polyethylene, polypropylene, polystyrene, polyether sulfone and polycarbonate, or may be a synthetic resin substrate using the plastic.

According to yet another exemplary embodiment, the sealing material may include an ultraviolet (UV) curing epoxy resin.

A second aspect of the present invention provides a method of measuring water and oxygen permeation rates of a protective layer in an organic electronic device, which includes: depositing a target protective layer of an organic electronic device on the water and oxygen permeable substrate of the permeation rate measuring device; measuring an amount of a change in resistance over time while applying a voltage to one ends of a pair of electrode layers of the device through an external resistance measuring device; substituting the measured resistance for Equation 1 below to measure an amount of a change in height of the calcium layer over time; and substituting the amount of a change in height of the calcium layer for Equations 2 and 3 below to measure water and oxygen permeation rates of the target protective layer of the organic electronic device,

$$\begin{matrix}Δ h = ( 1 - \frac{{R}_{i}}{R} ) {h}_{i} & Equation 1 \\ Water permeation rate = δ \frac{2 M ( {H}_{2} O )}{M ( Ca )} ( 1 - \frac{{R}_{i}}{R} ) {h}_{i} \frac{24 hr}{Δ hr} & Equation 2 \\ Oxygen permeation rate = δ \frac{0.5 M ( {O}_{2} )}{M ( Ca )} ( 1 - \frac{{R}_{i}}{R} ) {h}_{i} \frac{24 hr}{Δ hr} & Equation 3\end{matrix}$$

wherein in Equations 1 to 3, Δh is an amount of a change in height of the calcium layer (i.e., a height of the reacted calcium layer), R is a resistance of the calcium layer, Rᵢ is an initial resistance of the calcium layer, hᵢ is an initial height of the calcium layer (i.e., a height of deposited calcium), M(H₂O) is a molecular weight of water, M(Ca) is a molecular weight of calcium, M(O₂) is a molecular weight of oxygen, δ is a density of calcium, and Δhr is a lapsed time.

According to an exemplary embodiment of the present invention, the voltage may be applied in a range of 0.1 mV to 20 mV through an external resistance measuring device.

According to another exemplary embodiment, the method may further include measuring the water and oxygen permeation rates of the protective layer of the organic electronic device using the amount of a change in resistance over time with respect to the water and oxygen permeable substrate itself and the amount of a change in resistance over time with respect to the glass substrate, as reference values.

According to still another exemplary embodiment, the organic electronic device may be selected from the group consisting of an organic light emitting diode display device, an organic thin film transistor and an organic capacitor.

According to the present invention as described above, a device for measuring water and oxygen permeation rates of a protective layer in an organic electronic device and a method using the same can be provided, which use a principle that an electrical characteristic of the device is changed when the water or oxygen permeates the protective layer so that high reliability can be achieved, applicability to various processes for the protective layer in the organic electronic device can be enhanced without affecting a reflectance or a transmittance of the protective layer, and a defect averaging operation does not need to be performed on a calcium layer within the device unlike the conventional art.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a schematic plan view of a measuring device according to an exemplary embodiment of the present invention;

FIG. 2 is a schematic cross-sectional view of the device of FIG. 1 taken along line I-I of FIG. 1;

FIG. 3 is a graph showing water permeation characteristics when a glass substrate is applied (a) and a plastic substrate with no protective layer is applied (b) to the device shown in FIGS. 1 and 2 as a material to be measured; and

FIG. 4 is a graph showing water permeation characteristics when a typically conventional material for protective layer is further formed on the top of the plastic substrate (c) and both upper and lower surfaces of the plastic substrate (d) other than the glass substrate (a) and the plastic substrate (b) shown in FIG. 3.

### BRIEF DESCRIPTION OF THE REFERENCE NUMBERS FOR THE PRINCIPAL PARTS OF THE DRAWINGS

| | |
|---|---|
| 110, 120: Calcium Layers | 120, 220: Sealing material |
| 130, 230: Water and Oxygen | |
| permeable Substrates | |
| 140, 240: Protective Layers | 150, 250: Electrode Layers |
| 160, 260: Glass Substrates | 170, 270: Resistance measurement Device |

### DETAILED DESCRIPTION OF EXEMPLARY EMBODIMENTS

Hereinafter, exemplary embodiments of the present invention will be described in detail. The present invention is not limited to the exemplary embodiments disclosed below, but rather can be implemented in various forms. The following exemplary embodiments are described in order to fully enable those of ordinary skill in the art to embody and practice the present invention.

The present invention is devised in consideration of the principle that an electrical resistance of a reactive metal such as calcium susceptible to water and oxygen in an atmosphere is changed over time. In particular, calcium is a conductive metal but is transformed into calcium hydroxide having an electrically insulating property when it reacts with the water and oxygen in the atmosphere. Accordingly, when the change in resistance of calcium is measured over time, amounts of permeated water and oxygen can be quantitatively obtained from the amount of generated calcium hydroxide and the amount of residual calcium. At this time, chemical reactions between the calcium and the water and oxygen are shown in Equations 1 to 3:

Ca+H₂O→CaO+H₂| Equation 1

CaO+H₂O→Ca(OH)₂| Equation 2

2Ca+O₂→2CaO| Equation 3

One calcium atom reacts with two H₂O molecules to produce Ca(OH)₂ in Equations 1 and 2, and one calcium atom reacts with one half of an O₂ molecule to produce CaO in Equation 3. At this time, oxygen and water are independent and have different permeation mechanisms from each other, and an environment containing almost water and an environment containing almost oxygen in a hermetically sealed space are required in order to measure the permeation rates of water and oxygen, respectively. Accordingly, it is preferable to measure the water and oxygen permeation rates by a method of injecting the water or oxygen after setting an environment containing an inactive gas such as nitrogen within a measurement chamber.

In order to measure the water and oxygen permeation rates using the calcium, the present invention provides a device for measuring water and oxygen permeation rates of a protective layer in an organic electronic device, which includes: a glass substrate; a pair of electrode layers facing each other and deposited on the glass substrate; a calcium layer deposited on the glass substrate; a water and oxygen permeable substrate deposited on the calcium layer; a protective layer of an organic electronic device which is a measurement target and is deposited on the water and oxygen permeable substrate; and a sealing material applied along an edge of the target protective layer, wherein one ends of the electrode layers are buried in the calcium layer and the other ends are electrically connected to an external resistance measuring device.

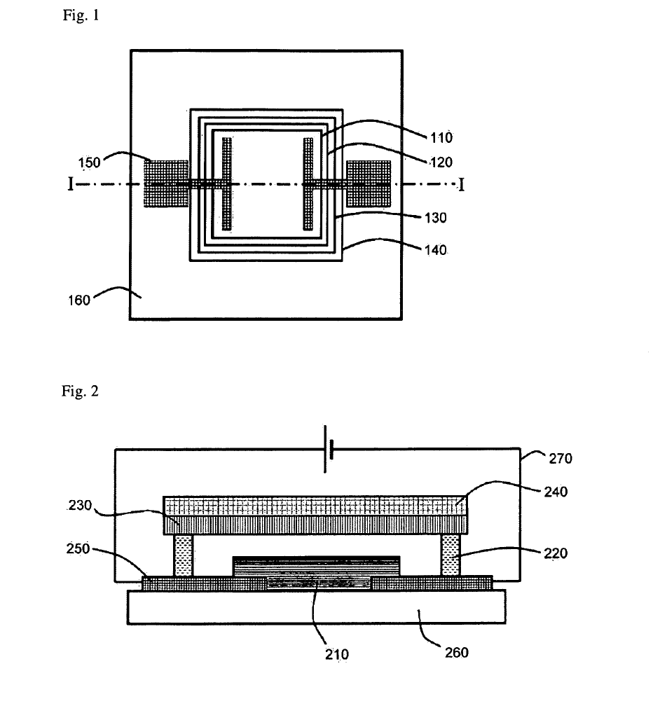

FIGS. 1 and 2 show schematic plan and cross-sectional views of a measurement device according to an exemplary embodiment of the present invention, respectively. Referring to FIGS. 1 and 2, a pair of electrode layers 150 and 250 is formed on glass substrates 160 and 260 by a thermal deposition process, respectively, wherein the glass substrate has a very low water permeation rate not greater than 10⁻⁶ g/m²/day.

The electrode layers 150 and 250 are metal layers which have a strong resistance to electrochemical corrosion and do not easily suffer from oxidation compared to other metals, so that the electrode layers are preferably metal layers having low resistance and low oxidation, in particular, Au or Ag material layers, but not limited thereto. This is because the electrochemical corrosion between the electrode layers 150 and 250 and probes of the external resistance measuring devices 170 and 270 or the oxidation of the electrode itself makes it impossible to accurately measure the permeation rate since the present invention employs a method of calculating the water permeation rate using electrical properties.

Calcium layers 110 and 210 are then formed on the electrode layers 150 and 250 as shown in FIGS. 1 and 2. Here, calcium is easily oxidized in an atmosphere as described above so that a thermal deposition chamber must have a high vacuum state not greater than 10⁻⁶ Torr at the time of formation of the calcium layers 110 and 210.

The calcium layers 110 and 210 preferably have a deposited thickness in a range of 50 nm to 500 nm, because it is difficult to deposit the calcium layer when the calcium layer has a thickness of less than 50 nm and it takes a long time to sense the change in electrical characteristics and measurement sensitivity is lowered when the calcium layer has a thickness of greater than 500 nm.

Subsequently, water and oxygen permeable substrates 130 and 230 are deposited on the calcium layers 110 and 210 in the device of the present invention, and must be formed of a material which can be applied to various processes for the protective layer and allows water and oxygen to be very easily permeated compared to the protective layer. Accordingly, the substrates 130 and 230 may be formed of plastic selected from the group consisting of polyethylene, polypropylene, polystyrene, polyether sulfone and polycarbonate, or may be a synthetic resin substrate using the plastic, but not limited thereto. The plastic substrates not only act as a support for supporting the protective layers 140 and 240 but also act to allow water and oxygen which have permeated the protective layers 140 and 240 to react with calcium in a short time so that water and oxygen permeation rates of the protective layers 140 and 240 can be evaluated.

Subsequently, sealing materials 120 and 220 are applied along an edge of the substrates where the protective layers 140 and 240 to be measured, i.e., the target protective layers, for permeations rates of water and oxygen are formed through an injection device, and then adhered to the substrates as shown in FIGS. 1 and 2 by a curing operation of the sealing material.

An ultraviolet (UV) curing epoxy resin may be used as the sealing materials 120 and 220.

In order to prevent the water permeation rate at the edge from becoming the overall permeation rate, the sealing materials 120 and 220 must block permeation of water and air, and to this end, multiple sealing materials may be applied at the edge or a getter may be provided to further block permeation of water and air at the edge.

The entire procedures of the process of fabricating the device of the present invention as described above are carried out in a glove-box system, i.e., in an environment containing an inactive gas such as nitrogen, and the thermal deposition chamber is also positioned within the glove-box system. The reason is to prevent the calcium layers 110 and 210 from being oxidized in the process of fabricating the device.

After the sealing materials 120 and 220 are cured, the device of the present invention including a sample to be measured is delivered into a measurement chamber set to a water or oxygen environment, and at this time, the other ends connected to one ends of the electrode layers buried by the calcium layers 110 and 210 are electrically connected to the external resistance measurement devices 170 and 270. The external resistance measurement devices 170 and 270 are capable of measuring a voltage or current over time, and may be a multimeter system such as Keithley 237, and the measurement is carried out using I-V curve over time.

The present invention also provides a method of measuring water and oxygen permeation rates of a protective layer in an organic electronic device, which includes: depositing a target protective layer of an organic electronic device on the water and oxygen permeable substrate of the permeation rate measuring device; measuring an amount of a change in resistance over time while applying a voltage to one ends of a pair of electrode layers of the device through an external resistance measuring device; substituting the measured resistance for Equation 1 below to measure an amount of a change in height of the calcium layer over time; and substituting the amount of a change in height of the calcium layer for Equations 2 and 3 below to measure water and oxygen permeation rates of the target protective layer of the organic electronic device,

$$\begin{matrix}Δ h = ( 1 - \frac{{R}_{i}}{R} ) {h}_{i} & Equation 1 \\ Water permeation rate = δ \frac{2 M ( {H}_{2} O )}{M ( Ca )} ( 1 - \frac{{R}_{i}}{R} ) {h}_{i} \frac{24 hr}{Δ hr} & Equation 2 \\ Oxygen permeation rate = δ \frac{0.5 M ( {O}_{2} )}{M ( Ca )} ( 1 - \frac{{R}_{i}}{R} ) {h}_{i} \frac{24 hr}{Δ hr} & Equation 3\end{matrix}$$

wherein in equations 1 to 3, Δh is an amount of a change in height of the calcium layer (i.e., a height of the reacted calcium layer), R is a resistance of the calcium layer, Rᵢ is an initial resistance of the calcium layer, hᵢ is an initial height of the calcium layer (i.e., a height of deposited calcium), M(H₂O) is a molecular weight of water, M(Ca) is a molecular weight of calcium, M(O₂) is a molecular weight of oxygen, δ is a density of calcium, and Δhr is a lapsed time.

At this time, the voltage to be applied is preferably in a range of 0.1 mV to 20 mV in order to minimize electrochemical corrosion between the electrode layers 150 and 250 and probes of the external resistance measuring devices, and a 4-point probe system for preventing electric leakage or minute oscillation of a current at the time of minute current measurement may be applied to the external resistance measuring devices.

In the device and method for measuring water and oxygen permeation rates according to the present invention, the water or oxygen permeation is carried out only through the water and oxygen permeable substrates 130 and 230 and the protective layers 140 and 240 deposited on the device. In other words, the water or oxygen permeation is hardly carried out through the electrode layers 150 and 250, the sealing materials 120 and 220 and the lower glass substrates 160 and 260, and when the water permeation is carried out in a range of 10⁻⁶ g/m²/day or less, the water permeation rate of the protective layer of the OLED is satisfied.

In the present invention, the principle of the change in resistance of the device is as follows. Oxidation starts from an upper surface of the calcium layers 110 and 210 due to the water permeation to cause a CaO layer to be generated on the upper surface of the calcium layers 110 and 210 in accordance with Equation 1, and when the water permeation is further developed, the CaO layer reacts with water to produce a Ca(OH)₂ layer in accordance with Equation 2 and the resistance increases more with such procedure being further developed.

Typically, the water permeation rate is represented as g/m²/day, and an initial height of calcium may be normalized to an initial current value (V/R) right after the measurement starts. For example, when calcium is transformed into calcium hydroxide having an insulating property, the resistance becomes infinite so that the current value also becomes zero. In this regard, the measurement of the resistance is an indication of the thickness, which may be effectively used for determining the water permeation rate. Consequently, a reduced height of the calcium layers 110 and 210 to the elapsed time may be derived from Equation 1 below through the change in electrical characteristics according to the oxidation of calcium layers 110 and 210:

$$Δ h = ( 1 - \frac{{R}_{i}}{R} ) {h}_{i} \qquad Equation 1$$

The change in height of the calcium layers obtained from Equation 1 may be substituted for Equations 2 and 3 below, so that it may be used for calculating the water and oxygen permeation rates:

$$\begin{matrix}Water permeation rate = δ \frac{2 M ( {H}_{2} O )}{M ( Ca )} ( 1 - \frac{{R}_{i}}{R} ) {h}_{i} \frac{24 hr}{Δ hr} & Equation 2 \\ Oxygen permeation rate = δ \frac{0.5 M ( {O}_{2} )}{M ( Ca )} ( 1 - \frac{{R}_{i}}{R} ) {h}_{i} \frac{24 hr}{Δ hr} & Equation 3\end{matrix}$$

In Equations 1 to 3, Δh is an amount of a change in height of the calcium layer (i.e., a height of the reacted calcium layer), R is a resistance of the calcium layer, Rᵢ is an initial resistance of the calcium layer, hᵢ is an initial height of the calcium layer (i.e., a height of deposited calcium), M(H₂O) is a molecular weight of water, M(Ca) is a molecular weight of calcium, M(O₂) is a molecular weight of oxygen, δ is a density of calcium, and Δhr is a lapsed time.

At this time, the amount of a change in resistance over time with respect to the water and oxygen permeable substrate itself and the amount of a change in resistance over time with respect to the glass substrate may be utilized as reference values for measuring the water and oxygen permeation rates of the protective layer which is a measurement target.

When the device or method of the present invention is actually applied, the reduction in height of calcium is not horizontally developed, for example, the change in resistance is horizontally dispersed to the same degree as the reduction in resistance of calcium even when one calcium molecule reacts with water or oxygen. This is possible on the assumption that the calcium layer is a collection of individual resistances. In terms of this, it can be seen that the present invention allows water and oxygen permeation rates to be accurately measured in a short time compared to the conventional methods.

The device or method of the present invention may be employed for measuring water and oxygen permeation rates of various organic electronic devices, for example, an organic electronic device selected from the group consisting of an OLED, an organic thin film transistor and an organic capacitor. In addition, besides the display applications, the device or method may be variously applied to processes which require the measurement of permeation of water and oxygen such as a substrate and encapsulation process and a microsystem packaging process.

### Embodiments

Fabrication of the Device According to the Present Invention

A glass substrate having a thickness of 1.1 mm was prepared as a substrate, an Ag electrode having a thickness of 250 nm was formed on the substrate, and a calcium layer having a thickness of 500 nm was deposited to bury an end of the electrode. A polyether sulfone plastic film having a thickness of 200 μm was used as a water and oxygen permeable substrate.

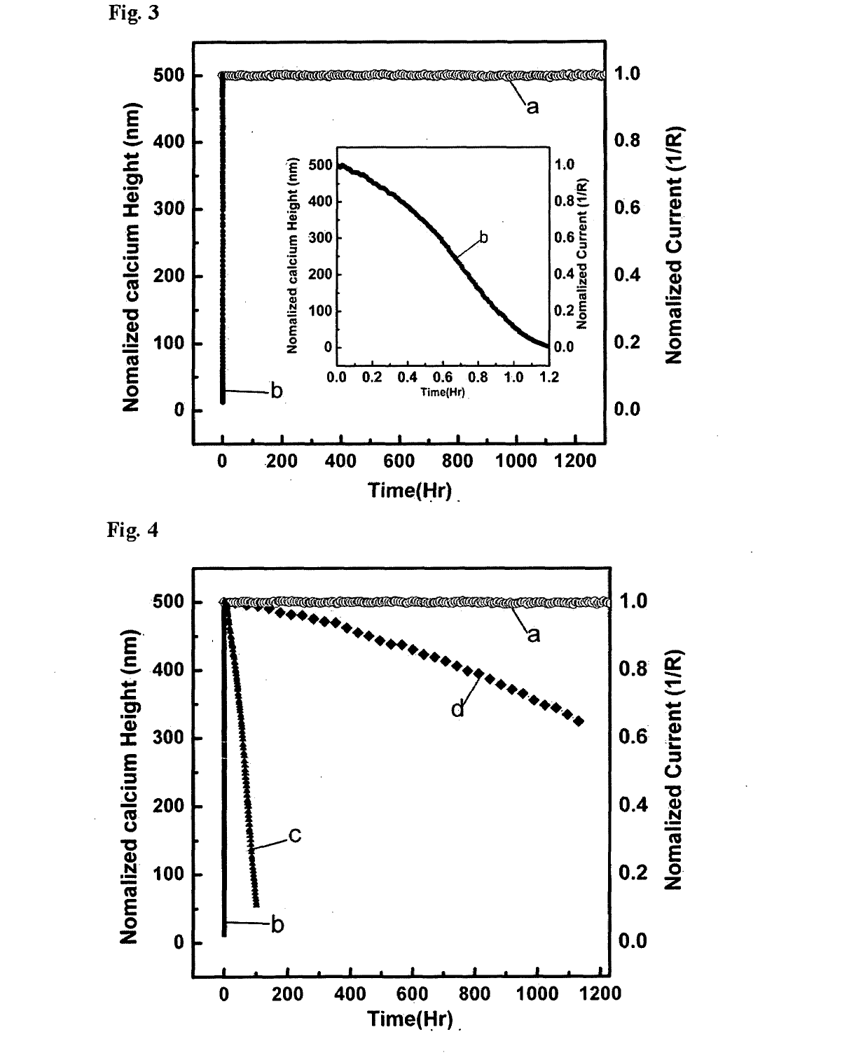

FIG. 3 is a graph showing water permeation characteristics when a glass substrate is applied (a) and a plastic substrate with no protective layer is applied (b) to the device shown in FIGS. 1 and 2 as a material to be measured.

Referring to FIG. 3, an x-axis denotes a lapsed time, and a y-axis denotes a degree of reduction in current when a constant voltage is continuously applied, i.e., a degree of reduction in height of calcium. Water permeation rates of the glass substrate (a) and the plastic substrate (b) are 10⁻⁶ g/m²/day and 10¹ g/m²/day, which are shown parallel in the x and y axes, respectively. This proves that the device of the present invention is well suitable for measuring the water permeation rate ranging from 10¹ g/m²/day to 10⁻⁶ g/m²/day. In addition, the inset graph of FIG. 3 shows the degree of reduction in height of calcium in a different time range when the plastic substrate is applied as the measurement target.

Measurement of Water Permeation Rate

An organic-inorganic thin film composed of an inorganic material and an organic material was used as the protective layer, wherein silicon oxide having a thickness of 50 nm was deposited as the inorganic material and acrylic-based resin having a thickness of 50 nm was deposited as the organic material.

FIG. 4 is a graph showing water permeation characteristics when the protective layer of the embodiment is formed on the top of the plastic substrate (c) and both upper and lower surfaces of the plastic substrate (d).

Referring to FIG. 4, it can be seen that a better water-proof effect can be achieved when the protective layer is formed on both upper and lower surfaces of the plastic substrate, and the water permeation rates are 10¹ g/m²/day and 10⁻³ g/m²/day through Equation 2 of measuring the water permeation rate in cases of (c) and (d), respectively.

According to the present invention as described above, a device for measuring water and oxygen permeation rates of a protective layer in an organic electronic device and a method using the same can be provided, which use a principle that an electrical characteristic of the device is changed when the water or oxygen permeates the protective layer so that high reliability can be achieved, applicability to various processes for the protective layer in the organic electronic device can be enhanced without affecting a reflectance or a transmittance of the protective layer, and a defect averaging operation does not need to be performed on a calcium layer within the device unlike the conventional art.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A device for measuring water and oxygen permeation rates of a protective layer in an organic electronic device, comprising:
a glass substrate;
a pair of electrode layers facing each other and deposited on the glass substrate;
a calcium layer deposited on the glass substrate;
a water and oxygen permeable substrate deposited on the calcium layer;
a target protective layer of an organic electronic device, which is deposited on the water and oxygen permeable substrate; and
a sealing material applied along an edge of the target protective layer,
wherein one ends of the pair of electrode layers are buried in the calcium layer and the other ends are electrically connected to an external resistance measuring device.

2. The device of claim 1, wherein the electrode layers are formed of an Ag material layer or an Au material layer.

3. The device of claim 1, wherein the calcium layer has a deposited thickness of 50 nm to 500 nm.

4. The device of claim 1, wherein the water and oxygen permeable substrate is formed of plastic selected from the group consisting of polyethylene, polypropylene, polystyrene, polyether sulfone and polycarbonate, or is a synthetic resin substrate using the plastic.

5. The device of claim 1, wherein the sealing material comprises an ultraviolet (UV) curing epoxy resin.

6. A method of measuring water and oxygen permeation rates of a protective layer in an organic electronic device, comprising:
depositing a target protective layer of an organic electronic device on the water and oxygen permeable substrate of the device according claim 1;
measuring an amount of a change in resistance over time while applying a voltage to one ends of a pair of electrode layers of the device through an external resistance measuring device;
substituting the measured resistance for Equation 1 below to measure an amount of a change in height of the calcium layer over time; and
substituting the amount of a change in height of the calcium layer for Equations is 2 and 3 below to measure water and oxygen permeation rates of the target protective layer of the organic electronic device,
$$\begin{matrix}Δ h = ( 1 - \frac{{R}_{i}}{R} ) {h}_{i} & Equation 1 \\ Water permeation rate = δ \frac{2 M ( {H}_{2} O )}{M ( Ca )} ( 1 - \frac{{R}_{i}}{R} ) {h}_{i} \frac{24 hr}{Δ hr} & Equation 2 \\ Oxygen permeation rate = δ \frac{0.5 M ( {O}_{2} )}{M ( Ca )} ( 1 - \frac{{R}_{i}}{R} ) {h}_{i} \frac{24 hr}{Δ hr} & Equation 3\end{matrix}$$
wherein in Equations 1 to 3, Δh is an amount of a change in height of the calcium layer (i.e., a height of the reacted calcium layer), R is a resistance of the calcium layer, Rᵢ is an initial resistance of the calcium layer, hᵢ is an initial height of the calcium layer (i.e., a height of deposited calcium), M(H₂O) is a molecular weight of water, M(Ca) is a molecular weight of calcium, M(O₂) is a molecular weight of oxygen, δ is a density of calcium, and Δhr is a lapsed time.

7. The method of claim 6, wherein the voltage is applied in a range of 0.1 mV to 20 mV through the external resistance measuring device.

8. The method of claim 6, further comprising:
measuring the water and oxygen permeation rates of the protective layer of the organic electronic device using the amount of a change in resistance over time with respect to the water and oxygen permeable substrate itself and the amount of a change in resistance over time with respect to the glass substrate, as reference values.

9. The method of claim 6, wherein the organic electronic device is selected from the group consisting of an organic light emitting diode display device, an organic thin film transistor and an organic capacitor.
